(19) United States
(12) Patent Application Publication
(10) Pub. No.: US 2009/0135622 A1
(43) Pub. Date: May 28, 2009

(54) A FLEXIBLE DISPLAY DEVICE

(75) Inventors: Mark T. JOHNSON, Veldhoven (NL); Hugo J. CORNELISSEN, Waalre (NL); Mark H.F. OVERWIJK, Son (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,000

(22) PCT Filed: Jul. 12, 2005
(86) PCT No.: PCT/IB05/52311

§ 371 Date: Jan. 12, 2007

(30) Foreign Application Priority Data
Jul. 15, 2004 (GB) 0415773.1

(51) Int. Cl. F21V 7/04; B05D 5/06

(52) U.S. Cl. 362/602; 427/64

(57) ABSTRACT

A flexible display device comprises a top, user-deformable layer, a bottom substrate layer, a spacing element spacing the top layer from the bottom layer, and a light source for supplying light to at least one of the bottom layer or the top layer, the display device emitting light when the top layer is deformed towards the bottom layer. The display device also includes a voltage source for applying a potential difference across a first electrode on the top user-deformable layer and a second electrode on the bottom substrate layer.

This invention relates to a flexible display device and to a method of forming a flexible display device.

Many different types of display devices are known. Traditional display devices such as televisions and flat panel monitors for computers are rigid devices that do not have any physical flexibility in them. For some time, there has been a desire to provide displays that are flexible, so that they can be, for example, rolled up or folded. It has also been a desire to include displays in clothing. Wearable displays are notoriously difficult to make robust. In addition to the need for some flexibility, one of the major weaknesses is the difficulty of providing all the electrical connections that are associated with classical flat panel matrix displays.

U.S. Pat. No. 6,653,997 discloses a display device that comprises row and column electrodes, a movable element and a power source for supplying voltages to the electrodes, wherein the row electrodes are situated on the movable element. The power source supplies, in operation, such voltages to the electrodes that use is made of the memory effect of the movable element. The row electrodes are, in operation, supplied with “on”, “off” and “hold” voltages and the column electrodes are supplied with “hold” and “off” voltages. The device of this patent is not flexible.

U.S. Pat. No. 6,511,198 discloses a light emitting polymer structure, which increase the versatility of the colouring and marking of surface areas of manufactured items, particularly fabric and garments. The display device of this patent is flexible, however it is based upon the use of bit sized electrodes, which greatly increases the weight and complexity of the display device and reduces the amount of flexibility available. Such a display device will also consume a relatively large amount of power.

It is therefore an object of the present invention to improve upon the known art.

According to a first aspect of the present invention, there is provided a flexible display device comprising a top, user-deformable layer, a bottom substrate layer, a spacing element spacing the top layer from the bottom layer, and a light source for supplying light to at least one of the bottom layer or the top layer, the display device emitting light when the top layer is deformed towards the bottom layer.

According to a second aspect of the present invention, there is provided a method of forming a flexible display device, comprising receiving and forming a top, user-deformable layer, a bottom substrate layer, a spacing element spacing the top layer from the bottom layer, and a light source for supplying light to at least one of the bottom layer or the top layer.

Owing to the invention, it is possible to provide a flexible display device that does not require individual addressing of pixels, does not use a large amount of power, but nevertheless provides a display suitable for use in flexible environments such as in garments. It is possible to create a robust wearable display with a minimal amount of electrical connections, which can be addressed using mechanical means such as a hand or pen or similarly shaped object.

Advantageously, the display device further comprises a voltage source for applying a potential difference across a first electrode on the top user-deformable layer and a second electrode on the bottom substrate layer. The voltage source is switchable, and can be switched to apply the same voltage to the first electrode and the second electrode. The provision of the voltage source helps to keep the top layer and bottom layer together, once the user has deformed the top layer. By switching the voltage source so that the same voltage is applied to both the top and bottom layers simultaneously, the layers are repelled from each other, and the display is effectively reset. An alternative method of resetting the display is to connect the first and second electrodes together, creating a short circuit.

Preferably, the display device further comprises a first insulating layer covering the first electrode, and a second insulating layer covering the second electrode. The insulating layer can be provided directly over the electrode, or can be provided after the spacing element is formed and thereby cover the spacing element as well. By providing one or two thin insulating layers (which can be transparent to light), power is saved. When the top and bottom layers are brought towards each other, the electrodes will not touch, and so no current will flow, saving power.

In a preferred embodiment, the voltage source is arranged to supply a stepped potential difference across the first electrode on the top user-deformable layer and the second electrode on the bottom substrate layer. This allows the provision of grey levels in the display device.

Advantageously, the spacing element is a grid element. By having the spacing element in the form of a grid, it is possible to simply and effectively space apart the top and bottom layers, without the likelihood that errors will occur. In a first embodiment of the spacing element, the thickness of the spacing element is substantially constant across its area. This is the simplest form of the spacing element, which is most easily manufactured. In a second embodiment of the spacing element, the thickness of the spacing element varies across its area. While being more complicated to manufacture, this form of the spacing element allows greater flexibility in the possible output of the finished display device, as it supports the use of grey scales in the display.

In one embodiment of the light source of the display device, the light source is located in the top, user-deformable layer, and comprises a fluorescent dye for absorbing ambient light. By using a dye to absorb ambient light and then re-emit this light as desired, power consumption is reduced. In a second embodiment of the light source, the light source is located on the spacer element. The light source can be an electro-luminescent material or a polymer/organic LED. In a third embodiment of the light source, the light source is located at one edge of the layers and supplies light into at least one of the bottom layer or the top layer. One example of this type of light source is a set of LEDs mounted on a flexible strip. This provides for flexible edge illumination of the display, thereby maintaining the flexibility of the display device.

Embodiments of the present invention will now be described, by way of example only, with reference to the accompanying drawings, in which:—

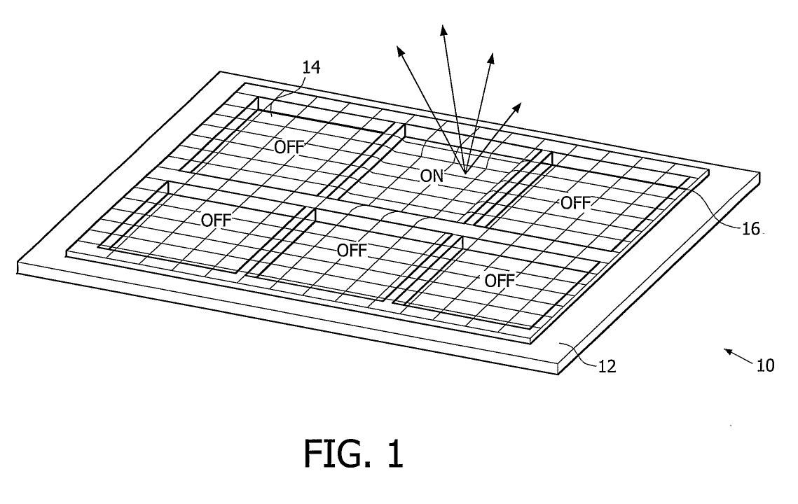

FIG. 1 is a top perspective view of a portion of a display device,

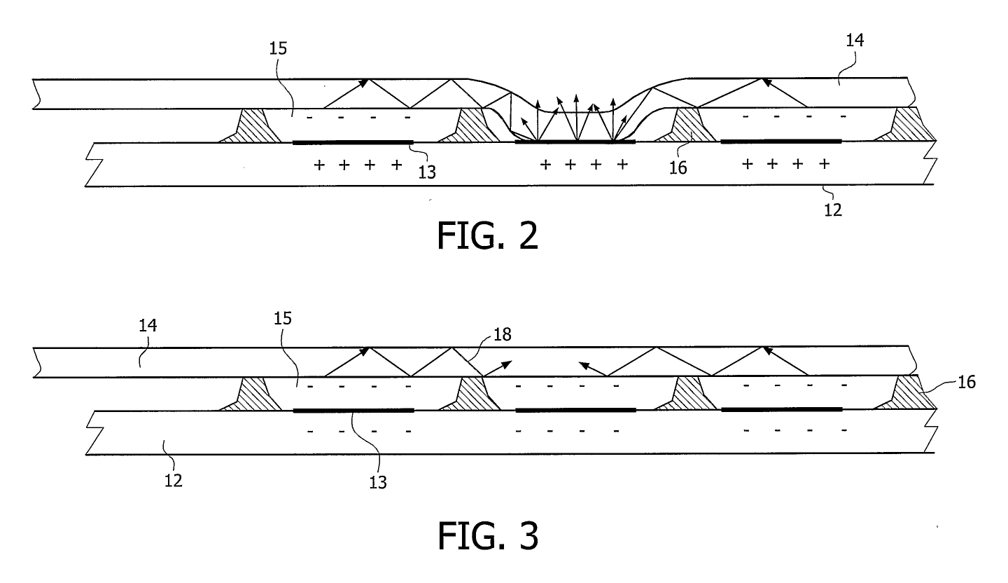

FIG. 2, is a cross-section through the display device of FIG. 1,

FIG. 3 is a view similar to FIG. 2, being a cross-section through the display device,

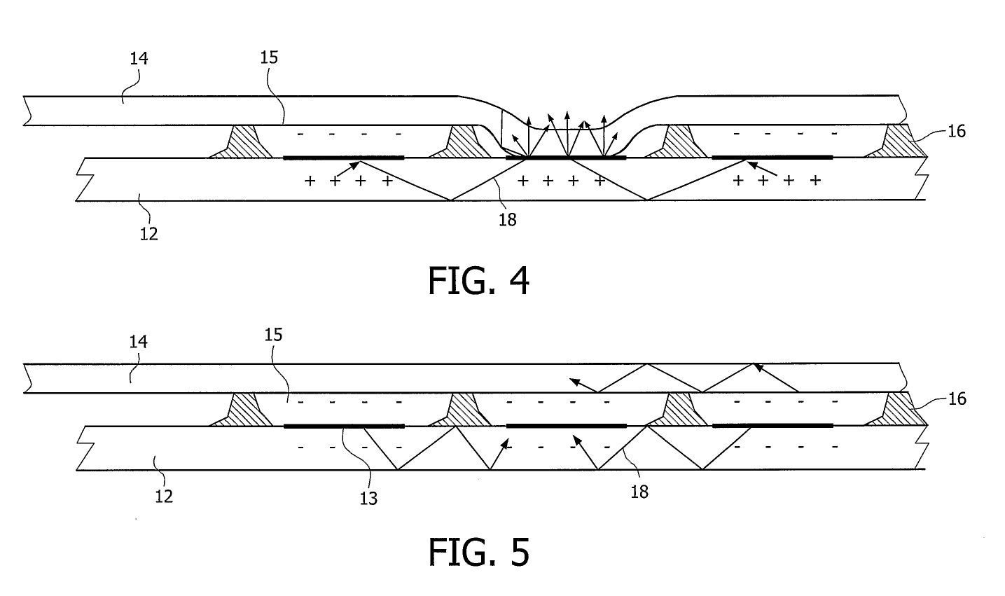

FIG. 4 is a cross-section through a second embodiment of the display device,

FIG. 5 is a view similar to FIG. 4, being a cross-section through the second embodiment of the display device,

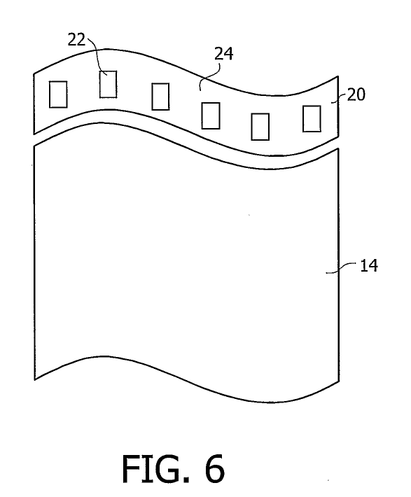

FIG. 6 is a schematic top plan view of the display device of FIG. 1,

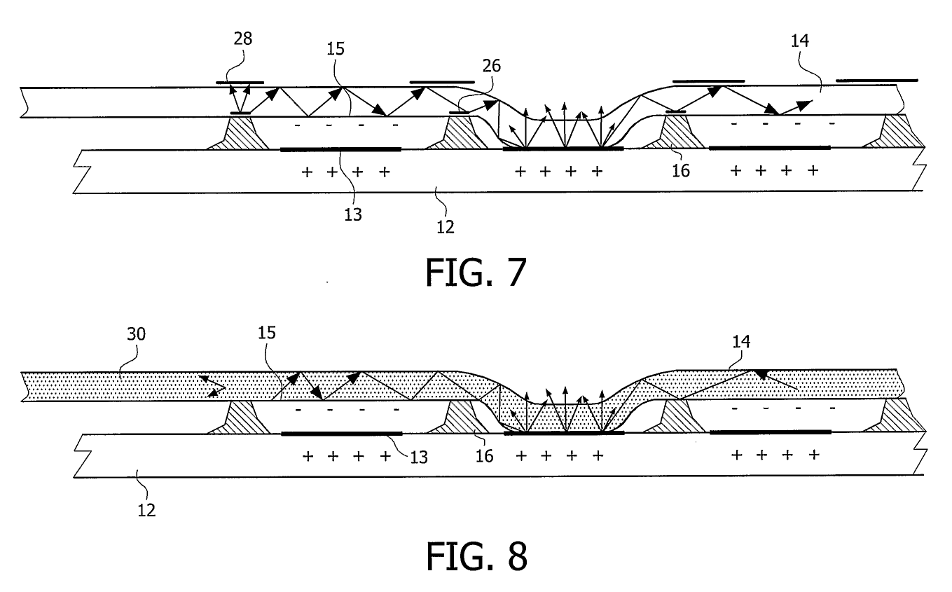

FIG. 7 is a cross-section through a third embodiment of the display device,

FIG. 8 is a cross-section through a fourth embodiment of the display device,

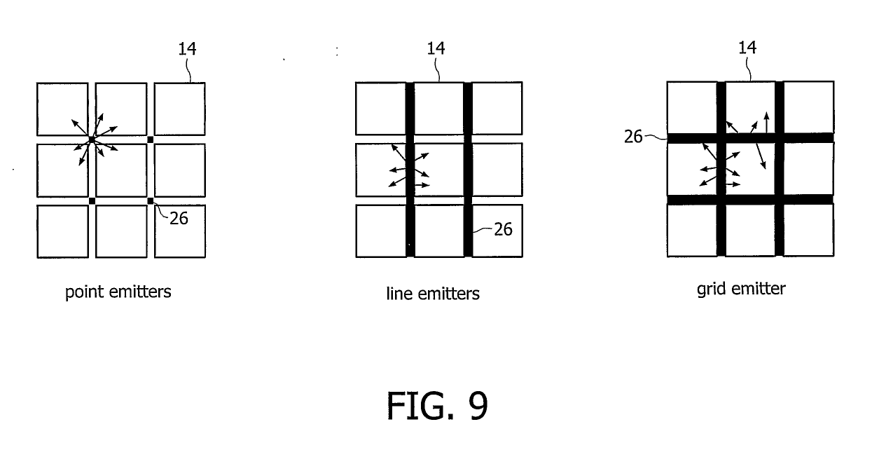

FIG. 9 is a schematic top plan of three alternative arrangements for the light sources,

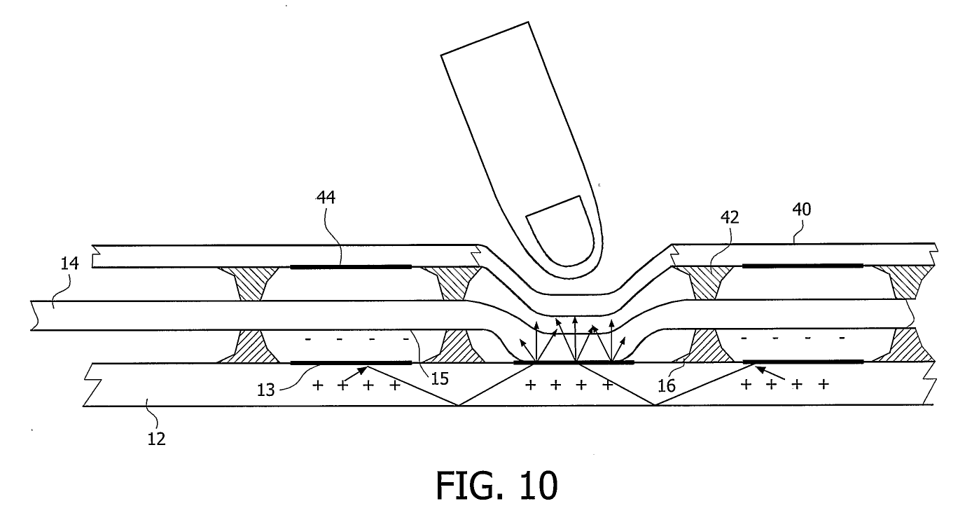

FIG. 10 is a cross-section through a fifth embodiment of the display device,

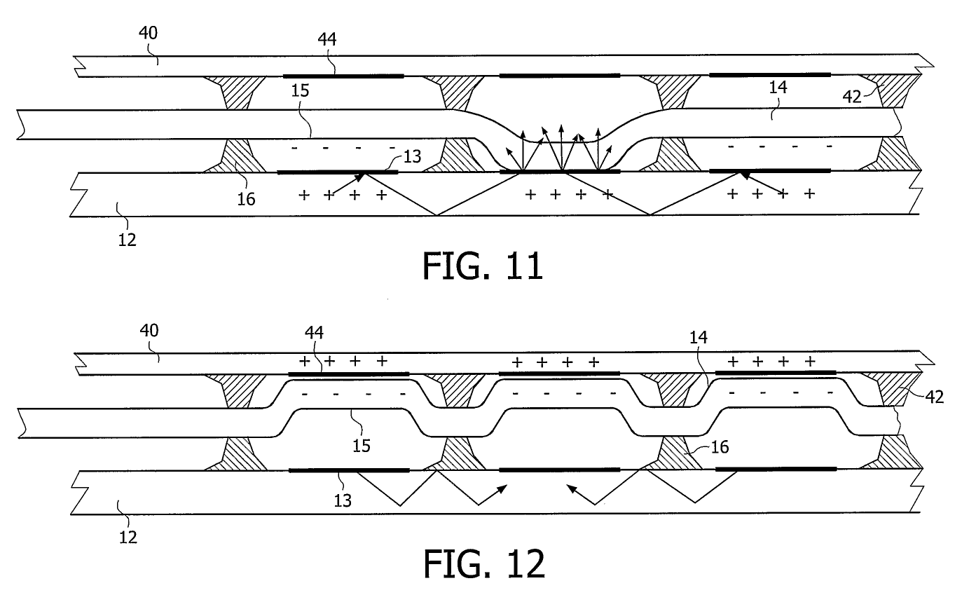

FIG. 11 is a view similar to FIG. 10, being a cross-section through the fifth embodiment of the display device, and

FIG. 12 is a view similar to FIGS. 10 and 11, being a cross-section through the fifth embodiment of the display device.

The basic embodiment of the invention is shown in FIG. 1, which illustrates the principle of operation of a mechanically addressed, electrically erasable, wearable display device 10. The display device 10 is built upon a first flexible foil, which is the bottom substrate layer 12, and as such will have similar mechanical properties to other “patches” which are commonly found on clothing (logo's, stripes etc.). A second, user-deformable foil layer 14 is separated from the bottom layer by a spacing element 16, which is spacing the top layer from the bottom layer. The spacing element 16 is a grid element, and the thickness of the spacing element 16 is substantially constant across its area, maintaining a uniform distance between the two layers 12 and 14.

The flexible display device 10 also includes a light source (not shown in this Figure) for supplying light to at least one of the bottom layer or the top layer, the display device 10 emitting light when the top layer 14 is deformed towards the bottom layer 12.

The primary mode of operation of the display device 10 is for a user to mechanically deform the top layer 14 so that the first and second layers 12 and 14 are optically contacted. This contacting of the layers 12 and 14 results in the brightness of the display device 10 being locally changed, with the result that an image may be formed. The display device 10 emits light when the top layer 14 is deformed towards the bottom layer 12.

FIG. 2 shows a cross-section through the display device 10. In this embodiment, light is captured in the user-deformable top layer 14. The light is only extracted when the bottom and top layers 12 and 14 are brought together. When this occurs, light is extracted by providing the bottom layer 12 with light scattering properties. In this manner, the image is created.

In order to maintain any image on the display device 10, a voltage is applied across two transparent electrodes 13 and 15. The display device 10 includes a voltage source (not shown) for applying a potential difference across the first electrode 15 and the second electrode 13. The voltage source is switchable, and can be switched to apply the same voltage to the two electrodes 13 and 15. The voltage source needs only a single connection to each electrode 13 and 15. These two electrical connections are the only ones required for the display device 10, irrespective of the display size, whereby a robust wearable display 10 with a minimal amount of electrical connections is realised. In the embodiment shown in FIG. 2, the electrode 13 on the bottom substrate layer 12 is charged positive, with the electrode 15 on the top, user-deformable layer 14 being charged negative.

The voltage that is provided by the voltage source is in itself insufficient to attract the electrodes 13 and 15 (and hence the two layers 12 and 14) together, as they are held apart by the spacing element 16 and the elastic properties of the two layers 12 and 14. However, by applying pressure to the display (by pressing it), the layers 12 and 14 can be brought sufficiently close together that the electrical attractive force on the electrodes 13 and 15 exceeds the elastic repulsion force of the layers 12 and 14. When this occurs, the layers 12 and 14 will make contact and light will be extracted, as described above. The image will be held on the display device 10, providing the voltage is maintained.

In the preferred embodiment, a thin transparent insulating layer covers one or both of the electrodes 13 and 15. This ensures that the voltage will be maintained without any current flowing, whereby this holding mode will not dissipate power. This is essential for a low power wearable application.

In order for the user to change the image displayed by the display device 10, it is first necessary to remove the presently displayed image. This is achieved by applying the same voltage to both electrodes 13 and 15. This can be implemented by simply electrically connecting the electrodes 13 and 15 on the two layers 12 and 14 (for example with a switch), or by applying the same voltage to both electrodes 13 and 15 from the voltage source. This is illustrated in FIG. 3. Once the two electrodes 13 and 15 are both at the same voltage, they are no longer attracted by the voltage, and the elasticity of the layers 12 and 14 results in the layer 14 being released, and no more light is extracted. The light (shown in the Figure as the arrow 18) is once more trapped within the layer 14, and is reflected within this layer, rather than emitted by the display device 10. Once the reset of the display device 10 is completed, the voltage can be reapplied and a new image can be written by the user on to the display device 10.

It will be appreciated, that whilst the above describes a display device 10 with only two electrical connections, additional connections could be used, if it is desired, to subdivide the display into a series of smaller sections, each of which could be individually addressed.

In a second embodiment of the display device 10, shown in FIGS. 4 and 5, the light 18 is captured in the bottom (less deformable) layer 12. Formation and holding of the image proceeds further in the manner described in the embodiment of FIGS. 2 and 3. The user brings together the two layers 14 and 12 with their finger or a suitable pointed device such as a pen, and this results in the light 18 being extracted from the bottom layer 12 and emitted from the display device 10. The two electrodes 13 and 15 on the two layers 12 and 14 are oppositely charged, and once they are brought together, the two layers 12 and 14 are held by the electrical attraction of the electrodes 13 and 15. As before, when it is desired to clear the display device 10, for applying a new image, then the voltage of the two electrodes 13 and 15 on the layers 12 and 14 is changed, so that they have the same voltage and repel each other, helped by the elastic forces.

An important aspect of the current invention is the manner in which light is captured into the foil layers 12 or 14. A known method of coupling light into a glass or foil substrate is to use an edge illumination with a fluorescent strip light or a LED stick, as is commonly used in backlight and front-light illumination systems. Such systems however are rigid, whereby the display becomes less bendable (at least in one direction). If such illumination were used in the display device 10, it preferably should be incorporated into a portion of a garment that is not usually bent, for example, a fixed shoulder pad or seam of the garment.

However, in a robust wearable display, it is preferable to make use of illumination methods that allow the display device 10 to maintain its flexibility. One such preferred embodiment is shown in FIG. 6, where the light capture is achieved by coupling light into the top, user-deformable layer 14. In this example, there is provided a modified edge illumination system. A light source 20 is located at one edge of the top layer 14 and supplies light into the top layer 14. The light source 20 is a set of LEDs (light emitting diodes) 22 mounted on a flexible strip 24. This provides for a flexible edge illumination of the display device 10.

In an alternative structure, shown in FIG. 7, it is possible to locally couple light into the top foil layer 14 at multiple positions across the display device 10. These positions could conveniently be at the positions of the spacing element 16, where light-generating elements 26 could be provided on (or in) the spacer ribs of the spacing element 16. Typically these light-generating elements 26 would be the known electro-luminescent foils, or alternatively an organic, or polymer LED.

The light source 26, for example an organic LED, is constructed by creating a three-layer structure on top of the spacing element 16. This three-layer structure consists of a lower electrode, a middle layer of the OLED, followed by a top electrode. The OLED emits light when a potential difference is applied across the two electrodes. These two electrodes that power the OLED, may be isolated from the first and second electrodes 13 and 15. Alternatively, one of the electrodes powering the OLED could be made common to either the first or second electrodes 13 or 15, and held at a common voltage, such as 0V (i.e. a ground or reference voltage).

Preferably, a reflective light shield 28 (mirror) would be situated at the opposite side of the top layer 14 to prevent direct emission of light that would not otherwise be internally reflected. The reflective light shield 28 may also be structured to ensure that reflected light is reflected at angles that ensure further internal reflection. If discrete light sources 26 are used, these can advantageously be distributed in the form of point, line or grid emitters, as these will all result in a uniform illumination across the entire display device 10 (these alternatives are shown in FIG. 9). Of these options, the line and grid emitters have the advantage that only continuous light emitting areas have to be created; there is no need for any extra electrical contact required between separate point emitting devices.

In another embodiment, shown in FIG. 8, ambient light is captured into the top layer 14 by incorporating a dye 30 into the top foil layer 14. The role of the fluorescent dye 30 is to absorb the ambient light inside the top layer 14 and to re-emit this at a specific wavelength spectrum. However, as the light is re-emitted in all directions, much of the light will be channelled through the foil layer by total internal emission. The captured light is locally emitted when the two layers 12 and 14 are brought together.

In all of the various embodiments of the display 10, the same underlying physical structure is used. The top deformable layer 14 is typically 10-100 micrometer thick, and can be manufactured from a number of different materials including:
Polydimethylsiloxane (PDMS) elastomer, which is widely used in microfluidic applications to form components such as channels, valves, and diaphragms. The PDMS material offers many advantages. It is transparent and biocompatible. It can be easily processed by molding and acquired for low costs. It is elastic and can form fluid seals,
Parylene,
Poly Ethylene Naphtalate (PEN),
Poly Ethylene Terephtalate (PET).

The spacing element 16 is typically 1-50 micrometers high, and can be made from photolithographic spacers made from photo-polymers or embossed ridges in PDMS.

The bottom layer 12 is typically 10-1000 micrometer thick and can be manufactured from the following:
PolyDiMethylSiloxane (PDMS) with scattering particles such as Titanium dioxide Ti02,
PolyEthyleneTerephtalate (PET) with Ti02, or
PolyEthyleneNaphtalate (PEN) with Ti02.

To create the electrodes 13 and 15, a continuous pattern of conductive material, in the form of a patterned ITO layer, is fabricated onto the top and bottom foil layers 12 and 14. This pattern can be a mesh, or lines, or a continuous layer, but must be present in or substantially cover those areas that will constitute the “pixels” in the final display.

On the bottom foil layer 12, the spacing elements 16 are fabricated by embossing or by a photolithographic process. Then the top and bottom foil layers 12 and 14 are joined together and sealed.

In the display device 10, it is also desirable to have available methods of generating grey levels in the wearable, mechanically addressed display device 10. In the above embodiments, it is possible to achieve an image of bright and dark areas, however, the appearance of the display device 10 is greatly improved if it is possible to introduce some grey levels. This can be achieved in one of two of the following methods.

The force required to bring the two foil layers in sufficiently close contact for them to make electrostatic contact will depend upon their stiffness. In one embodiment, the thickness of the spacing element 16 varies across its area, thereby creating variable separation between the spacer walls. In this case, it will in general be easier to compress the top, user-deformable layer 14 where the spacer separation is larger, as these areas are less stiff. Areas where the spacer separation is smaller will be more difficult to bring into contact, as these areas are stiffer. In this way, grey levels can be created in a natural manner by pressing the display device 10 harder to create brighter (or wider) lines. In this embodiment, only a single voltage is required to hold the image.

In a second method of achieving grey scales, it is possible to introduce grey scales in a sequential manner, by introducing more than one image holding voltage level. This is achieved using a stepwise increasing holding voltage. Here, the concept that a higher voltage will more strongly attract the foil layers 12 and 14 is utilised, whereby the chance of attracting the foil layers 12 and 14 together increases. In this example, with the smallest attracting voltage, only a small number of pixels will be sufficiently attracted to come into contact, whilst at the higher voltage, almost all pressed pixels will come into contact. Therefore, an image can be drawn by starting from the dark grey levels (low voltage) to the lighter grey levels (higher voltage). As the voltage is increasing, all contacted areas of the two layers 12 and 14 will not be released until a new image is required and a reset is introduced.

Whilst all above embodiments describe a display with an image that is static once written, it is also possible to create dynamic effects in the display device 10. As an example, using a cycling or pulsing voltage across the two layers 12 and 14 can create a flashing impression. As the voltage is decreased, a situation will occur where the foil layers 12 and 14 begin to release from each other. As this will begin to occur close to the spacing element 16 (where the elastic force is highest), this will result in a reduction in brightness of the image (as the layers 12 and 14 now make contact over a smaller area). If however, the voltage is again increased before the layers 12 and 14 are completely separated, the layers 12 and 14 will again be more attracted to each other and an increase in brightness of the image will occur (as the layers 12 and 14 now make contact over a larger area). In this manner, the image will start to flash.

In a still further embodiment, shown in FIGS. 10 to 12, the display device 10 comprises a further user-deformable layer 40, positioned at the opposite side of the top user-deformable layer 14 to the bottom substrate layer 12 and separated from the top layer 14 by a further spacing element 42. The further user-deformable layer 40 has an additional electrode 44 on the side facing the top layer 14 and is provided with a voltage source.

The further electrode 44 is used to provide a voltage difference relative to the first electrode 15, and hence create an electric force to attract the top layer 14 away from the bottom substrate layer 12. This force will be in addition to the elastic force, and hence constitute a stronger repulsive force to aid the erasing of the image. During forming of a new image, shown in FIG. 10, the voltage of the further electrode 44 will be set substantially equal to the first electrode 15, whereby no electric force will be present, and an image is formed by deforming both the top layer 14 and the further layer 40.

FIG. 11 shows the image being held once it has been formed by the user, and FIG. 12 shows the action of the device 10 when the resetting voltage is applied across the further electrode 44 and first electrode 15.

An important advantage of the further user deformable layer 40 is that it makes the device more rugged. It acts as a protective layer to prevent damage to the user-deformable layer 14. As a consequence the user-deformable layer 14 can be made thinner, facilitating its deformation and lowering the voltages needed for erasure of the images.

1. A flexible display device comprising a top, user-deformable layer, a bottom substrate layer, a spacing element spacing the top layer from the bottom layer, and a light source for supplying light to at least one of the bottom layer or the top layer, the display device emitting light when the top layer is deformed towards the bottom layer.

2. The device of claim 1, including a voltage source for applying a potential difference across a first electrode on the top user-deformable layer and a second electrode on the bottom substrate layer.

3. The device of claim 2, wherein the voltage source is switchable, and can be switched to apply the same voltage to the first electrode and the second electrode.

4. The device of claim 2, wherein the first electrode and the second electrode can be connected together.

5. The device of claim 2, including a first insulating layer covering the first electrode.

6. The device of claim 2, including a second insulating layer covering the second electrode.

7. The device of claim 5, wherein the or each insulating layer covers substantially all of electrode.

8. The device of claim 2, wherein the voltage source is arranged to supply a stepped potential difference across the first electrode on the top user-deformable layer and the second electrode on the bottom substrate layer.

9. The device of claim 1, wherein the spacing element is a grid element.

10. The device of claim 1, wherein the thickness of the spacing element is substantially constant across its area.

11. The device of claim 1, wherein the thickness of the spacing element varies across its area.

12. The device of claim 1, wherein the light source comprises a fluorescent dye for absorbing ambient light.

13. The device of claim 1, wherein the light source is located on the spacing element.

14. The device of claim 1, wherein the light source is located on the top or bottom layers (14, 12) at the position of the spacing element.

15. The device of claim 1, wherein the light source is located at one edge of the layers and supplies light into at least one of the bottom layer or the top layer.

16. The device of claim 15, wherein the light source is a set of LEDs mounted on a flexible strip.

17. The device of claim 1, including a further user-deformable layer and a further spacing element spacing the further user-deformable layer from the top, user-deformable layer.

18. The device of claim 17, including an additional electrode on the further user-deformable layer.

19. A method of forming a flexible display device, comprising receiving a bottom substrate layer, applying a spacing element to the bottom layer, applying a top, user-deformable layer to the spacing element and providing a light source for supplying light to at least one of the bottom layer or the top layer.

20. The method of claim 19, including applying a first electrode to the top user-deformable layer, applying a second electrode to the bottom substrate layer, and connecting a voltage source to the first electrode and the second electrode.

21. The method of claim 20, wherein the first electrode and the second electrode are so formed that they can be connected together.

22. The method of claim 20 including applying a first insulating layer between the first electrode and the spacing element.

23. The method of claim 20, including applying a second insulating layer between the second electrode and the spacing element.

24. The method of claim 19, wherein the spacing element is a grid element.

25. The method of claim 19, wherein the thickness of the spacing element is substantially constant across its area.

26. The method of claim 19, wherein the thickness of the spacing element varies across its area.

27. The method of claim 19, wherein the light source comprises a fluorescent dye for absorbing ambient light.

28. The method of claim 19, wherein the light source is located on the spacing element.

29. The method of claim 19, wherein the light source is located at one edge of the layers and supplies light into at least one of the bottom layer or the top layer.

30. The method of claim 29, wherein the light source is a set of LEDs mounted on a flexible strip.

31. The method of claim 19, including applying a further user-deformable layer and a further spacing element spacing the further user-deformable layer from the top, user-deformable layer.

32. The method of claim 31, including applying an additional electrode on the further user-deformable layer.
